(19) United States
(12) Patent Application Publication
(10) Pub. No.: US 2024/0347751 A1
(43) Pub. Date: Oct. 17, 2024

(54) Making an Electrochemical Membrane from Low T(alpha) Fluorinated Ionomer Salts

(71) Applicant: 3M INNOVATIVE PROPERTIES COMPANY, St. Paul, MN (US)

(72) Inventors: Matthew J. Lindell, Woodbury, MN (US); Gregory M. Haugen, Edina, MN (US); Michael A. Yandrasits, Hastings, MN (US)

(21) Appl. No.: 18/580,310

(22) PCT Filed: Jul. 11, 2022
(86) PCT No.: PCT/IB2022/056399

§ 371 Date: Jan. 18, 2024

Related U.S. Application Data
(60) Provisional application No. 63/226,253, filed on Jul. 28, 2021.

(51) Int. Cl. H01M 8/1039; C08F 8/30; H01M 8/10; H01M 8/103; H01M 8/1032; H01M 8/18

(52) U.S. Cl. CPC H01M 8/1039; C08F 8/30; H01M 8/103; H01M 8/1032; H01M 8/188; H01M 2008/1095; H01M 2300/0082

(57) ABSTRACT

Described herein is a method of making a polymer electrolyte membrane, the method comprising: disposing a liquid composition on a substrate, wherein the liquid composition comprises an ionic fluorinated polymer, wherein the ionic fluorinated polymer comprises a plurality of side chains having a protogenic group in a salt form, and wherein the ionic fluorinated polymer has a T(a) of less than 200° C. Such polymer electrolyte membranes may be used in electrochemical cells, such as a flow cell battery.

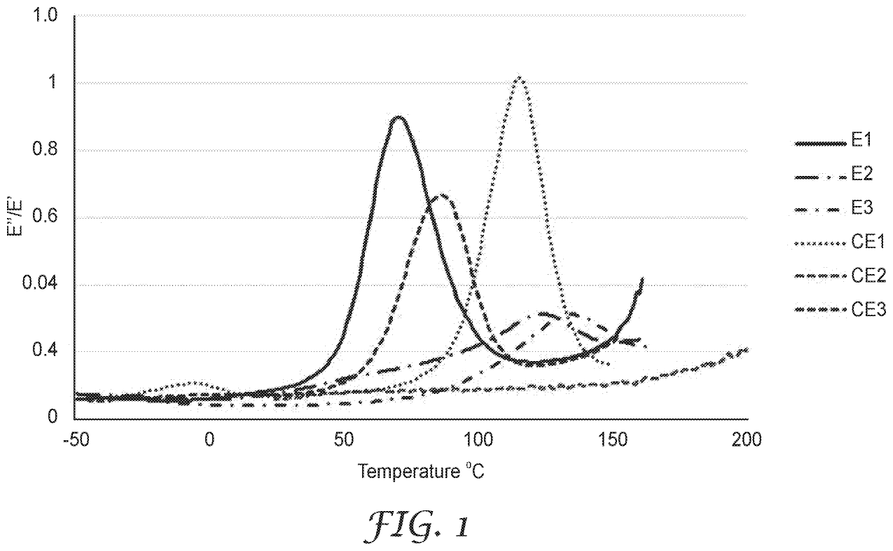

### TECHNICAL FIELD

A method of making a polymer electrolyte membrane for electrochemical cells is disclosed, wherein a fluorinated polymer comprising a plurality of protogenic side chains is cast in its salt form. Such fluorinated polymers have a T(α) of less than 200° C. enabling their casting at temperatures less than 200° C.

### BACKGROUND

Electrochemical devices, including proton exchange membrane fuel cells (PEMFCs), sensors, electrolyzers, chlor-aikali separation membranes, redox flow batteries, and the like, typically comprise an ion conducting membrane or polymer electrolyte membrane sandwiched between a cathode and an anode. The polymer electrolyte membrane facilitates charge movement between the anode and cathode enabling function of the electrochemical device.

### SUMMARY

When manufacturing the polymer electrolyte membrane, it is standard practice to coat a fluorinated ionomer (i.e., a fluorinated polymer comprising protogenic groups) in its acidic form into a polymer electrolyte membrane. The acidic groups of the membrane are then converted into their salt form. This conversion usually takes place in aqueous based solutions and can add additional time, and/or cost to membrane manufacture. Thus, there is a desire to identify fluorinated ionomers that can be manufactured into a membrane in their salt form.

In one aspect, a method of making a polymer electrolyte membrane is described, the method comprising disposing a liquid composition on a substrate, wherein the liquid composition comprises an ionic fluorinated polymer, wherein the ionic fluorinated polymer comprises a plurality of side chains having a protogenic group in a salt form, and wherein the ionic fluorinated polymer has a T(α) of less than 200° C.

In another aspect, a polymer electrolyte membrane is described. The polymer electrolyte membrane is made by disposing a liquid composition on a substrate, wherein the liquid composition comprises an ionic fluorinated polymer, wherein the ionic fluorinated polymer comprises a plurality of side chains having a protogenic group in a salt form, and wherein the ionic fluorinated polymer has a T(α) of less than 200° C.; and annealing the ionic fluorinate polymer on the substrate.

In another aspect, an electrochemical cell is described. The electrochemical cell comprises a membrane made by disposing a liquid composition on a substrate, wherein the liquid composition comprises an ionic fluorinated polymer, wherein the ionic fluorinated polymer comprises a plurality of side chains having a protogenic group in a salt form, and wherein the ionic fluorinated polymer has a T(α) of less than 200° C.

In one embodiment, the electrochemical cell is a flow battery.

In yet another aspect, a method of method of making sulfonyl fluoride-containing polymer into a bis(sulfonyl)imide salt polymer, the method comprising:
reacting a polymer comprising a plurality of side chains having a sulfonyl fluoride group with ammonia to form a corresponding sulfonamide polymer;
treating the corresponding sulfonamide polymer with an excess of aprotic amine to generate a corresponding sulfonamide trialkylammonium salt;
treating the sulfonamide trialklammonium salt with another small molecule sulfonyl fluoride to generate a corresponding bis(sulfonyl)imide polymer; and contacting the corresponding bis(sulfonyl)imide polymer with a hydroxide base to form the bis(sulfonyl)imide salt polymer

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term
“a”, “an”, and “the” are used interchangeably and mean one or more; and
“and/or” is used to indicate one or both stated cases may occur, for example, A and/or B includes (A and B) and (A or B);
“equivalent weight” (EW) of a polymer means the weight of polymer that will neutralize one equivalent of base, which includes all protogenic groups including sulfonic acids, sulfonamides, bis(perfluoroalkylsulfonyl)imides, etc.;
“electrolyte membrane” means a membrane comprising ion containing polymers (also known as an ion exchange membrane) in which the ion containing polymers typically contain primarily either bound cations or bound anions. The counterions of the polymers' bound ions can migrate through the membrane polymer matrix, particularly under the influence of an electric field or a concentration gradient;
“highly fluorinated” refers to wherein at least 75%, 80%. 85%, 90%, 95%, or even 99% of the C—H bonds of the polymer are replaced by C—F bonds, and the remainder of the C—H bonds are selected from C—H bonds, C—Cl bonds, C—Br bonds, and combinations thereof;
“perfluorinated” means a group or a compound wherein all carbon-hydrogen bonds have been replaced by carbon-fluorine bonds. A perfluorinated compound may contain other atoms than fluorine and carbon atoms, like oxygen atoms, nitrogen atoms, chlorine atoms, bromine atoms and iodine atoms;
“protogenic group” refers to an acidic functional group capable of dissociating a proton;
“polymer” refers to a macrostructure having a number average molecular weight (Mn) of at least 10,000 g/mol (gram/mole), at least 25,000 g/mol, at least 50,000 g/mol, at least 100,000 g/mol, at least 300,000 g/mol, at least 500,000 g/mol, at least, 750,000 g/mol, at least 1,000,000 g/mol, or even at least 1,500,000 g/mol and not such a high molecular weight as to prevent processability; and
“polymer backbone” refers to the main continuous chain of the polymer.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The ionomer of the present disclosure is a highly fluorinated or even perfluorinated polymer that comprises a plurality of side chains along the polymer backbone. At least a portion of the plurality of side chains comprise at least one protogenic group. Exemplary protogenic groups include: a bis(sulfonyl)imide salts, a sulfonyl methide salts, and mixtures thereof.

In one embodiment, the protogenic group is a bis(sulfonyl)imide,

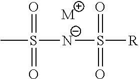

moiety, wherein M^{⊕} is a suitable counter cation and R is a monovalent partially fluorinated, preferably perfluorinated, alkyl group. In one embodiment, R comprises 1, 2, 3, or even 4 carbon atoms, and at most 6, 8, 10, or even 12 carbon atoms. Such polymers comprising a plurality of side chains having a bis(sulfonyl)imide moiety can be made using techniques known in the art. For example, a sulfonamide moiety can be reacted with a fluorinated alkylsulfonyl fluoride in the presence of an aprotic alkyl amine to yield the bis(sulfonyl)imide.

In one embodiment, the protogenic group comprises a sulfonyl methide moiety,

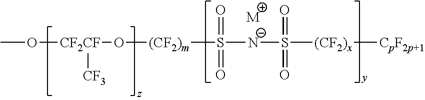

wherein M^{⊕} is a suitable counter cation. In one embodiment, the protogenic group is

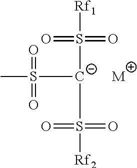

wherein M^{⊕} is a suitable counter cation, and R_{f1} and R_{f2} are independently selected from monovalent perfluorinated alkyl groups comprising 1 to 12 carbon atoms, more preferably from 1-4 carbon atoms. Such polymers comprising a plurality of side chains, having a sulfonyl methide moiety can be made using techniques known in the art. For example, a methyl Grignard reagent (i.e. CH₃MgBr) can be reacted with a sulfonyl fluoride sidechain followed by reaction of two additional equivalents of fluorinated alkylsulfonyl small molecules to generate the desired methide moiety, such as that described in Inorg. Chem., 1988, vol. 27, issue 12, pages 2135-2137.

In one embodiment, the side chain comprising the protogenic group is a perfluorinated carbon chain that is interrupted by and/or terminated by a protogenic group. In one embodiment, the side chain comprises on average at least 2, 4, or even 6 carbon atoms, and at most 10, 12, 14, 16, 18 or even 20, excluding the carbon located along the polymer backbone. In one embodiment, the side chain comprises at least one catenary heteroatom, such as oxygen (i.e., ether linkage).

Exemplary protogenic side chains comprise:

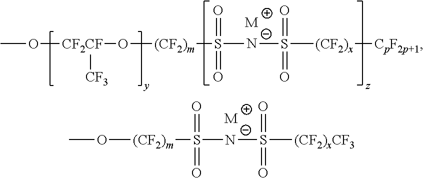

and mixtures thereof, wherein M^{⊕} is a suitable counter cation; x is 0, 1, 2, 3, 4, 5, or 6; and m is 2, 3, 4, 5, or 6; p is 1, 2, 3, 4, 5, or 6; y is 0, 1, 2, or 3; and z is 1, 2, or 3.

In one embodiment, the ionic fluorinated polymer may comprise other pendent protogenic groups, such as sulfonamide, sulfonic acid, and salts thereof. If the ionic fluorinated polymer comprises sides chains with these additional protogenic groups, the number of these protogenic groups should be small enough, such that the ionic fluorinated polymer achieves its desired T(α) (for example, less than 200° C.).

As used herein, the suitable counter cation, M^{⊕}, refers to any charged metal ion, which charge balances the ionic fluorinated polymer including, for example, those having a charge of +1, +2, +3, +4, +5, +6, etc. Such metal ions can comprise, for example, the alkali and alkaline earth metals, lanthanides, transition metals, and mixtures thereof. In the present disclosure, the protogenic group is in its salt form during the manufacture of the polymer electrolyte membrane, preferably a metal salt form, wherein the metal, or suitable counter cation includes, for example, alkali metals such as lithium, sodium, potassium, etc.; alkaline earth metals, such as calcium, magnesium, beryllium, etc.; transition metals such as manganese, vanadium, cesium, iron, chromium, etc., and lanthanide metals such as cerium, etc. In one embodiment, manganese and/or cerium may be advantageous as a counter cation due to their chemical stabilizing effect in certain electrochemical applications.

The protogenic groups are located on pendent groups, or side chains, off of a polymer backbone. Suitable polymer backbones may comprise polymers or co-polymers of vinyl groups, styrene groups, perfluoroethylene groups, acrylate groups, ethylene groups, propylene groups, epoxy groups, urethane groups, ester groups, and other groups known to those skilled in the art. In one embodiment, the polymer backbone is fluorinated, either partially fluorinated (comprising both carbon-hydrogen bonds and carbon-fluorine bonds) or fully fluorinated (comprising carbon-fluorine bonds and no carbon-hydrogen bonds). In one embodiment, the ionic fluorinated polymer is derived from interpolymerized fluorinated monomers including tetrafluoroethylene, hexafluoropropylene, vinyl fluoride, vinylidene fluoride, fluorinated ether monomers (for example, perfluoro (methyl vinyl) ether, perfluoro (ethyl vinyl) ether, perfluoro (n-propyl vinyl) ether, perfluoro-2-propoxypropylvinyl ether, perfluoro-3-methoxy-n-propylvinyl ether, etc.) and other monomers as known in the art.

In one embodiment, the fluorinated polymer's backbone is derived from at least 20, 50, 100, 500, or even 1000 repeating monomeric units.

The polymer and/or the resulting polymeric electrolyte membrane should be sufficiently conductive for use in electrochemical cells. In one embodiment, when measured in the acid forn (e.g., the ionic fluorinated polymer in its acid form, or the polymer electrolyte membrane in its acid form), the ionic fluorinated polymer and/or the resulting polymeric electrolyte membrane has a conductivity of at least 10, 20, or even 30 mS/cm and at most 50, 60, 70, 80, 90, or even 100 mS/cm (milliSiemens per centimeter) at 50% relative humidity (RH) and 80° C.

In one embodiment, the ionic fluorinated polymer of the present disclosure has an equivalent weight (EW) of at least 700, or even 800, and at most 1200, 1100, 1000, or even 900 grams/mole.

Ionomers typically exhibit a thermal transition between a state in which the ionic clusters are closely associated and a state in which the interactions between those clusters have been weakened. The dominant thermal transition of the bulk polymer is described as an alpha transition, and the transition temperature is T(α).

Traditionally, ion exchange membranes for electrochemical applications are coated or cast in their acid form, since the salt form has a higher T(α), which makes processing more difficult. The cast polymers are then dried and annealed to form an ion exchange membrane in its acid form. The ion exchange membranes are then subsequently converted to their salt form. However, to convert a membrane from its acid form to its corresponding salt form, an aqueous based composition is needed.

In the present disclosure, it has been discovered that certain ionomers in their salt form have lower T(α)'s and thus, can be used directly to make an ion exchange membrane. In one embodiment, the salt form of the ionomer has a T(α) of less than 200, 190, 180, 170, 160, 150, or even 130° C. Generally, the T(α) of a cationic fluorinated polymer in its acid form is less than in its corresponding salt form. In one embodiment, the difference between the T(α) of the cationic fluorinated polymer in its acid form is at least 20, 40 or even 60° C. less than the same cationic fluorinated polymer in its salt form.

The T(α) of a polymer can be determined using dynamic mechanical analysis as exemplified below. The ratio of the loss modulus, E″, to the elastic modulus, E′ is plotted versus temperature and the dominant maxima is the T(α) temperature.

The electrolyte membranes may be made using techniques known in the art.

In the present disclosure, a liquid composition comprising the ionic fluorinated polymer in its salt form is used to make the polymer electrolyte membrane.

In one embodiment, the liquid composition additionally comprises a solvent. Exemplary solvents include water, organic polar solvents such as N,N-dimethylfonnamide, N,N-dimethylacetamide, dimethylsulfoxide, N-methyl-2-pyrrolidone, and hexamethylphosphoramide, and alcohols such as methanol and ethanol and the like can be used. Typically, the amount of solvent, if present, in the liquid composition is at least 50, 60, 70, or even 75% and at most 80, 85, 90, 95, 99, or even 99.5% by mass.

In one embodiment, the liquid composition further comprising a solvent is disposed onto a temporary support using a coating technique to form a layer. Any suitable coating method may be used, including bar coating, spray coating, slit coating, knife coating, gravure coating, brush coating, and the like.

In yet another embodiment, the liquid composition is disposed onto a porous supporting matrix substrate and allowed to imbibe the substrate. Any suitable supporting matrix may be used as known in the art. Typically, the supporting matrix is electrically non-conductive. Typically, the supporting matrix is composed of a fluoropolymer, which is more typically perfluorinated. Typical matrices include porous polytetrafluoroethylene (PTFE), such as biaxially stretched PTFE webs. Other exemplary porous supports include fiberglass, polymer fibers, fiber mats, perforated films, and porous ceramics. Overpressure, vacuum, wicking, immersion, and the like may be used to imbibe the polymer. The polymer becomes embedded in the matrix upon crosslinking. In one embodiment, the supporting matrix has a thickness of at least 5, 10, 15, 20, 35, 30, or even 35 micrometers; and at most 100, 75, or even 50 micrometers.

In still another embodiment, the dry ionomer in its salt form that is melt-processable is heated and compressed to form a block, which is then skived with a sharp blade using a process called skiving to form a continuous strip of film; such skiving technologies are used in polytetrafluoroethylene (PTFE) processing.

In one embodiment, the liquid composition is disposed onto a temporary support that is not intended for final use. The temporary substrate is used during the manufacture or storage to support and/or protect the polymer electrolyte membrane. The temporary substrate is removed from the polymer electrolyte membrane prior to use, for example adjoining the polymer electrolyte membrane to an electrode. The temporary substrate comprises a backing often coated with a release coating. The polymer electrolyte membrane is disposed on the release coating, which allows for easy, clean removal of the polymer electrolyte membrane from the temporary substrate. Such transfer substrates are known in the art. Typically, the backing is comprised of a material having a high temperature stability (i.e., the backing won't melt during processing at the desired temperatures above the T(α) of the fluorinated polymer of the present disclosure) and is usually more expensive. However, advantageously, the ionomers of the present disclosure can be processed at lower temperatures on less expensive temporary substrates such as polyolefins (including polypropylene and polyethylene) or polyester (including polyethylene terephthalate, and nylon) backings.

Examples of release agents that may be coated on the backing include carbamates, urethanes, silicones, fluorocarbons, fluorosilicones, and combinations thereof, Carbamate release agents generally have long side chains and relatively high softening points. An exemplary carbamate release agent is polyvinyl octadecyl carbamate, available from Anderson Development Co. of Adrian, Mich., under the trade designation “ESCOAT P20”, and from Mayzo Inc. of Norcross, GA, marketed in various grades as RA-95H, RA-95HS, RA-155 and RA-585S. Illustrative examples of surface-applied (i.e., topical) release agents include polyvinyl carbarnates such as disclosed in U.S. Pat. No. 2,532,011 (Dahlquist et al.), reactive silicones, fluorochemical polymers, epoxysilicones such as are disclosed in U.S. Pat. No. 4,313,988 (Bany et al.) and U.S. Pat. No. 4,482,687 (Kessel et al.), polyorganosiloxane-polyurea block copolymers such as are disclosed in European Appl. No. 250,248 (Leir et al.), etc. Silicone release agents generally comprise an organopolysiloxane polymer comprising at least two crosslinkable reactive groups, e.g., two ethylenically-unsaturated organic groups. In some embodiments, the silicone polymer comprises two terminal crosslinkable groups, e.g., two terminal ethylenically-unsaturated groups. In some embodiments, the silicone polymer comprises pendant functional groups, e.g., pendant ethylenically-unsaturated organic groups. In some embodiments, the silicone polymer has a vinyl equivalent weight of no greater than 20000, 15000, or even 10,000 grams per equivalent. In some embodiments, the silicone polymer has a vinyl equivalent weight of at least 250, 500, or even 1000 grams per equivalent. In some embodiments, the silicone polymer has a vinyl equivalent weight of 500 to 5000 grams per equivalent, e.g., 750 to 4000 grams per equivalent, or even 1000 to 3000 grams per equivalent. Commercially available silicone polymers include those available under the trade designations “DMS-V” from Gelest Inc., e.g., DMS-V05, DMS-V21, DMS-V22, DMS-V25, DMS-V31, and DMS-V33. Other commercially available silicone polymers comprising an average of at least two ethylenically-unsaturated organic groups include “SYL-OFF 2-7170” and “SYL-OFF 7850” (available from Dow Corning Corporation, Midland, MI), “VMS-T11” and “SIT7900” (available from Gelest Inc., Morrisville, PA), “SILMER VIN 70”, “SILMER VIN 100” and “SILMER VIN 200” (available from Siltech Corporation, East York, ON, Canada), and 2,4,6,8-tetramethyl-2,4,6,8-tetravinylcyclotetrasiloxane (available from Sigma Aldrich, St. Louis, MO). The release agent may also comprise a fluorosilicone polymer. Commercially available ethylenically unsaturated fluorosilicone polymers are available from Dow Corning Corp. under the SYL-OFF series of trade designations including, e.g., “SYL-OFF FOPS-7785” and “SYL-OFF FOPS-7786”. Other ethylenically unsaturated fluorosilicone polymers are commercially available from General Electric Co. (Albany, NY), and Wacker Chemie (Germany). Additional useful ethylenically unsaturated fluorosilicone polymers are described as component (e) at column 5, line 67 through column 7, line 27 of U.S. Pat. No. 5,082,706 (Tangney). Fluorosilicone polymers are particularly useful in forming release coating compositions when combined with a suitable crosslinking agent. One useful crosslinking agent is available under the trade designation “SYL-OFF Q2-7560” from Dow Coring Corp. Other useful crosslinking agents are disclosed in U.S. Pat. No. 5,082,706 (Tangney) and U.S. Pat. No. 5,578,381 (Hamada et al.).

After disposing the ionic fluorinate polymer onto a substrate, the article if comprising a solvent, is typically dried to at least partially remove solvent. The ionic fluorinated polymers disposed on a support are annealed to form a useable polymeric electrolyte membrane.

As is known in the art, annealing is used to turn a film into a robust, continuous solid phase film. During the formation of a film from a casting process, there is a gradual coalescence of latex particles by interdiffusion of their constituent polymer chains. The first step is the relatively rapid diffusion of short chains and chain ends, while the second, and much slower, step of interpenetration and entanglement of long chains results in greatly increased robustness of the final film. Heat is used not to cure (or cause a chemical change of the polymer), but instead to aid diffusion and entanglement of the polymer.

In one embodiment, the ionomer of the present disclosure is annealed at a temperature below 220, 200, 180, or even 160° C. In one embodiment, the ionomer is annealed at a temperature of at least 20, 30, 40, 60, or even 80° C. higher than the first T(α) of the ionomer. Typically, heating to a temperature no more than 220° C.

In one embodiment, the resulting polymer electrolyte membrane of the present disclosure has a thickness of at most 200, 90, 60, or even 40 micrometers, and at least 10, 15, 20, 35, 30, or even 35 micrometers.

In addition to the ionomer, the polymeric electrolyte membrane may further comprise a filler. Exemplary fillers include silica, titanium dioxide, vanadium oxide or a polymer (e.g., polyvinylidene fluoride, polytetrafluoroethylene, etc.). Such fillers may be added to the liquid composition prior to casting or blended with the polymer prior to extrusion.

In one embodiment, the polymer of the present disclosure is blended with a second polymer to form a polymer electrolyte membrane. In one embodiment, the second polymer may be a continuous phase, while the polymer of the present disclosure is a discontinuous phase. Exemplary second polymers include: fluorinated and partially fluorinated polymers such as PTFE, poly vinylidene fluoride, and copolymers including hexafluoropropylene; aromatic backbone polymers such as poly ether ketone, and poly ether sulfone; and basic polymers such as polybenzimidazole.

As mentioned, because the polymer electrolyte membranes of the present disclosure are initially made from the ionomer in its salt form, no conversion in aqueous solutions is needed.

Thus, in one embodiment, the polymer electrolyte membranes of the present disclosure are substantially free (i.e., less than 10, 8, 5, 3, or even 1 wt %) of water.

In one embodiment, a polymeric electrolyte membrane may be made by modifying a polymer into a bis(sulfonyl)imide salt as follows.

First, a fluorinated polymer comprising a pendent sulfonyl fluoride group is reacted with ammonia to form the corresponding sulfonamide at a temperature of at most 0° C. in an aprotic solvent such as acetonitrile.

Rf-SO₂F+NH₃→Rf-SO₂NH—NH₄++NH₄F

Then, the corresponding sulfonamide is treated with an aprotic amine (NR_) to make the corresponding Rf-SO₂NH—NHR₃+. An excess of aprotic amine is used to catalyze the reaction with Rf2-SO₂F, which generates the corresponding Rf-SO₂N(NHR₃+)SO₂—Rf2 (bis(sulfonyl)imide trialkylammonium salt) after reacting with a small molecule sulfonyl fluoride (for example having a molecular weight of at least 50, 100, or even 200 grams/mole and at most 500, 1000, 1500, or even 2000 grams/mole).

The aprotic amine is removed with a hydroxide base to form a salt. The salt form may or may not be the counter cation desired for use.

Optionally, the salt form of the polymer is dispersed in water and optionally purified using techniques known in the art.

If the salt form of the polymer is not the form desired for end use, the polymer can be converted into the desired salt form by ion exchanging the polymer into the acid form and then ion exchanging the acid form of the polymer with the desired counter cation to achieve the desired salt.

The dry polymer can be dispersed in a solvent and then disposed on a substrate and annealed as described above.

In one embodiment, the polymeric electrolyte membranes of the present disclosure have good physical properties. For example, the polymeric electrolyte membranes do not dissolve in the catholyte and/or anolyte (e.g., of a flow battery); and the polymeric electrolyte is dimensionally stable upon swelling.

In one embodiment, the electrolyte membrane of the present disclosure may contain various enhancing layers such as glass paper, glass cloth, ceramic nonwoven fabric, porous base materials, and nonwoven fabric as needed. In one embodiment, the electrolyte membrane of the present disclosure is in intimate contact with a second polymeric layer to form a membrane having two distinct layers. Such second polymeric layers include, for example, a polyfluorosulfonic acid, or a porous support membrane that can be laminated or surface coated onto the electrolyte membrane of the present disclosure.

In one embodiment, the polymeric electrolyte membrane of the present disclosure may be used in an electrochemical cell (e.g., fuel cell, redox flow battery, etc.).

The polymeric electrolyte membrane of the present disclosure may be placed between two electrodes, the anode and cathode, which comprise a metal. In some embodiments, the electrode is for example carbon paper, carbon felt, or carbon cloth, or a porous metal mesh. The membrane and the two electrodes are sandwiched between current collector plates, which optionally have a field flow pattern etched thereon, and then held together such that each layer is in contact, preferably intimate contact with the adjacent layers to form an electrochemical cell.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

These abbreviations are used in the following examples: A=amp, aq=aqueous, cm=centimeters, g=grams, oC=degrees Celsius, h=hour, Hz=Hertz, kVA=kilovolt-amprere, L=liter, mm=millimeters, min=minute, M=molar, mol=moles, N=Newton, rad=radian, see second, RH=relative humidity, rpm=revolutions per minute, psig=pounds per square inch gauge, ppm=parts per million, and V=volt.

TABLE 1
Table of Materials
Materials Used in the Examples

| Abbreviation | Description | Source |
|---|---|---|
| NH₃ | Ammonia, Anhydrous | Matheson, Basking Ridge, NJ |
| | Amberlite IR120 H⁺ ion exchange resin | Rohm and Haas, Philadelphia, |
| | beads | PA |
| EtOH | Ethanol - Koptec, 200 proof | DLI, King of Prussia, PA |
| MeOH | Methanol - BDH | VWR Analytical, Radnor, PA |
| TFMSF | Trifluoromethylsulfonyl Fluoride | 3M Company, St. Paul, MN |
| DI H₂O | Deionized water, 18 MegaOhm, Barnstead | Thermo Scientific, Waltham, |
| | GenPure System | MA |
| TEA | Triethylamine, TX1200-5 | EMD Millipore Corp, |
| | | Darmstadt, Germany |
| PPDSF | 1,3-Perfluoropropanedisulfonyl Fluoride | 3M Company, St. Paul, MN |
| | Amberlite IR120 Na⁺ form, Stock# 42833 | Alfa Aesar, Ward Hill, MA |
| KOH | Potassium Hydroxide, BDH9262 | VWR International, Radnor, |
| | | PA |
| LiOH•H₂O | Lithium hydroxide monohydrate, A15519 | Alfa Aesar, Heysham, England |
| NaCl | Sodium Chloride, GR ACS, SX0420-1 | EMD Millipore Corp., |
| | | Darmstadt, Germany |

### Test Methods

### Titration of Films (EW Measurement)

Membranes dried at 120° C. for 20 minutes were weighed and added to 50 g 1 M NaCl(aq). The membranes were allowed to ion exchange for more than 4 hours with gentle agitation by rolling or shaking in a bottle. The HCl generated was titrated with 0.01 to 0.03 M NaOH to determine the ion exchange capacity of the film with known mass.

Sample preparation for Dynamic Mechanical Analysis (DMA):

Sample films were removed from their substrates and vacuum dried at 80° C. overnight and stored over activated molecular sieves in a tightly sealed glass jar until testing. At the DMA instrument, sample films were removed from jars and quickly cut with a double-knife slot cutter to 6.2 mm width. Thickness, around 20-50 micrometers, was measured by a digital micrometer and the length of sample mounted was approximately 6-8 mm, determined by the instrument per sample.

### Dynamic Mechanical Analysis (DMA-1)

A Rheometrics Solid Analyzer (RSA II) (Piscataway, NJ) at 1 Hz (6.28 rad/sec) was used. A typical thin strip of sample was mounted in the clamps and tightened. Pre-determined amplitude and frequency was applied to the thin film sample and stress response of the material was measured. Before measuring the sample, the sample was first heated from 25° C. to 110° C. to drive off water and then cooled to 25° C. The sample once cooled, was then ramped to 200° C. in tension for measurement. Elastic modulus, E′, and loss modulus, E″, were measured. T(α) was determined at the maximum of tan-delta, the ratio of E″/E′.

### Dynamic Mechanical Analysis (DMA-2)

Elastic moduli of film samples in tension mode were measured using a TA Instruments (New Castle, DE) DMA Q800 at 1 Hz (6.28 rad/sec). A typical thin strip of sample was mounted in the clamps and tightened. The temperature of the furnace was ramped to 70° C. at 5° C./min, held isothermal for 5 minutes, and ramped (at approximately 9-10° C./min) to −50° C. The analysis was run with a 15 micrometer amplitude strain and 0.01 N pre-stress from −50° C. to a temperature in which the sample yielded, typically below 200° C. The Elastic modulus, E′, and loss modulus, E″, were measured. T(α) was determined at the maximum of tan-delta, the ratio of E″/E′.

### Sulfonamide Content Determination

Sulfonamide content of copolymers was measured by a nuclear magnetic spectrometer (obtained under the trade designation “BRUKER A500 NMR”, from Bruker Corp, Billerica, MA) and calculated by comparing the ¹⁹F spectrum CF₂ peak integrations associated sulfonyl fluoride, sulfonamide, bis(sulfonyl)imide and sulfonic acid functional groups that are found between −107 and −126 ppm.

### Film Coating Method-1:

Membranes were prepared by casting the dispersion onto a 2 mil (51 micrometer) thick polyimide film (obtained under the trade designation “KAPTON”, available from DuPont (Wilmington, DE)) or 2 mil thick PTFE film (TFV 002-R24, Plastics International, Eden Prairie, MN) upon a glass substrate using a 4 inch (10.2 cm) wide microfilm applicator (obtained from Paul N. Gardner Company, Inc., Pompano Beach, FL) with a wet gap thickness of 8-15 mils (0.2-0.38 mm) which was uniform across the 4 inch width of the coating. The wet coating was dried under an aluminum pan covering in a forced air oven at 120° C. for 30 minutes. The polyimide, or PTFE, and coating were transferred from the glass substrate to an aluminum pan with aluminum pan covering and heated to 140° C. for 15 minutes and ramped to an anneal temperature, described per example, with a 10 minute hold to produce an approximately 30 micrometer thick proton exchange membrane. The films were removed from the polyimide, or PTFE, and titrated according to the EW Measurement method.

### Film Coating Method-2:

Dispersions of ionomer were coated onto a 2 mil (51 micrometer) polyimide liner (KAPTON, available from DuPont (Wilmington, DE)) at a constant flow rate using a coating die and a line speed of about 1 meter per minute, with a target dry thickness, using a pilot-scale coater manufactured by Hirano Entec Ltd. (Nara, Japan) having four drying zones arranged sequentially in a down-web direction and set to 50° C., 100° C., 120° C., and 145° C., respectively. The films were then subjected to a second heat treatment as indicated per example.

### Preparatory Examples

### Perfluorosulfonyl Fluoride (PFSF) Synthesis (PE1):

FSO₂—(CF₂)₄—OCF═CF₂ was prepared as described in U.S. Pat. No. 6,624,328 (Guerra). Tetrafluoroethylene and FSO₂C₄F₈OCF═CF₂ were copolymerized as described in U.S. Pat. No. 7,348,088 (Hamrock et al.). The resulting fluoropolymer:

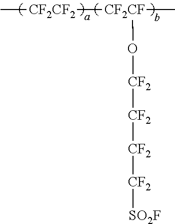

had an equivalent weight of 798 g/mol, wherein a=19.2 mol % of polymerized sulfonyl fluoride functional monomer and b=80.8 mol % of polymerized tetrafluoroethylene comonomer. The resulting fluoropolymer had a melt flow index of 32 g/10 min at 265° C., 5 kg mass. The sulfonyl fluoride functional fluoropolymer was sieved through a wire mesh and the fluoropolymer having a particle size <1 mm was used for the subsequent reactions.

### Perfluorosulfonamide Triethylammonium (PFSAmide TEAH) Synthesis (PE2):

PE1 from above was converted to the sulfonamide form and converted into the triethylammonium salt according to Preparatory Example 1 of U.S. Pat. No. 9,419,300 (Hamrock et al.), using a larger scale version of the process. PE1 was converted to a sulfonamide functionalized polymer of similar composition with sidechains having 29:1 sulfonamide (—SO₂NH₂) to sulfonic acid (SO₃H) functionality as determined by the Sulfonamide Content Determination method above. In the present process, the sulfonamide ammonium was further reacted with triethylamine (TEA) and slowly heated under reduced pressure to remove the ammonia. In a nitrogen-inerted vacuum oven, the polymer mixture was dried upon a polytetrafluoroethylene (PTFE) release liner at 85° C. The resulting dried polymer comprised

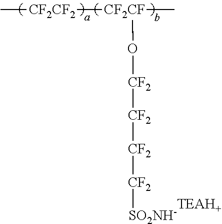

wherein a and b are the same as above.

Perfluoromethylbis(sulfonyl)imide (PFMI) Synthesis (PE3):

To a 1 L Parr Instruments (Moline, IL) stirred reactor fitted with a single turbine agitator, thermowell, pressure gauge and two needle valve regulated inlet ports, that had been heated and cooled under N₂(g) flow to dry, 149.52 g (0.17 mol) PE2 was charged to the reactor. The reactor was sealed and evacuated. 391.8 g (21 equiv.) triethylamine was transferred by cannula into the evacuated reactor. The reactor was cooled over an IPA/CO₂(s) bath with modest stirring ˜150 rpm while monitoring the temperature. A cylinder of TFMSF was set upon a mass balance to observe mass change as the reagent was added to the reactor. Once a temperature below −20° C. was achieved, 284.5 g (11.2 equiv.) TFMSF was condensed into the reactor. The reactor inlet valve was closed and the dry ice bath was exchanged for a heating mantle (335 W, 115 V, Cat. No. 0572, Glas-Col Apparatus Company, Terre Haute, IN) controlled by a variable autotransformer (120 V input, 0-120 V output, 10 A, 1.4 kVA, Staco Energy Products, Dayton, OH). Temperature was ramped to 48° C. (75 psig) over 1 h, to 60° C. (99 psig) over 14.5 h, increased agitation rate to ˜250 rpm and held for 2 h. Cooled to 21° C. (20 psig) over 3.5 h. Gaseous TFMSF was bubbled into excess liquid ammonia to trap excess TFMSF as trifluoromethylsulfonamide ammonium salt; once the vessel was at 1 atm., headspace was flushed with N₂(g) into the liquid ammonia. The reaction solids were collected over a Whatman grade GF/B glass fiber filter (GE Healthcare UK Limited, Buckinghamshire, UK) upon a Buchner funnel. Solids were washed with 250 mL H₂O and MeOH. Rotary evaporated in a 2 L 1-neck round-bottomed flask (RBF) at 57° C., 0.16 atm to obtain 183.54 g solids. Added 430 mL 2 M LiOH and 325 mL EtOH and rotary evaporated at the same temperature with varying pressure to obtain 284.62 g of the Li salt polymer and other lithium salts comprising:

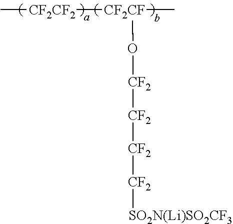

wherein a and b are the same as above.

### PFMI H⁺ Dispersion (PE4)

Solids from PE3 were dispersed in H₂O over 5 runs in a 600 mL stirred reactor (Parr Instruments Company) with a single turbine agitator. Dispersions were accomplished by charging the product lithium salts, up to 18 wt %, with an additional 4-5 equiv. LiOH·H₂O (s) (A15519, Alfa Aesar, Heysham, England), heating the reactor to 250° C. with a 1 hour hold with agitation rates around 250 RPM. Dispersions were combined after filtering through 1 micrometer glass fiber Acrodisc syringe filters (REF 4524T, Pall Corporation, Puerto Rico). The dispersions were purified by cross flow filtration and were dried by rotavapping to concentrated solution and further to solids under nitrogen blow down at room temperature. The solids were redispersed at room temperature into 85/15 MeOH/H₂O (w/w) solvent at 9.39% solids to obtain a 1566 g dispersion.

An ion exchange column with Amberlite IR120 H⁺ containing 1.8 mol H⁺ sites was washed with several gallons of deionized water. The beads were treated with 1 L 85/15 MeOH/H₂O followed by the PE3 polymer Li⁺ dispersion. Followed dispersion with 85/15 MeOH/H₂O (w/w) solvent to collect a total of 2413.34 g H form dispersion at 5.87% solids.

### PFMI H⁺ Solid (PE5)

1561 g of the PFMI H⁺ dispersion (PE4) above was rotavapped in a 2 L 1-neck RBF at 50° C. to remove the majority of MeOH. The sample was then dried in the oven at 100° C. until dry to collect 97.126 g PFMI H⁺ polymer. ¹⁹F NMR of the polymer in deuterated methanol showed 76.8% conversion of sulfonamides to perfluoromethyl bis(sulfonyl)imide functional sidechains. The polymer comprises

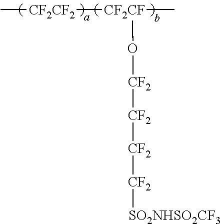

wherein a and b are the same as above.

### PFMI Na⁺ (PE6):

To a column, 0.792 mol H⁺ sites Amberlite IR120 Na form (Stock #42833, Alfa Aesar, Ward Hill, MA) was added and washed with several gallons of DI H₂O. 426 g PFMI H⁺ dispersion (PE4) was run over the column followed by air, with an entire collection at pH 7. MeOH was stripped by rotary evaporation at 60° C., varying pressures and aqueous dispersion was oven dried at 100° C. to collect 25.96 g PFMI Na⁺ solids.

### PFMI K⁺ (PE7):

In a 2 L bottle, 203 g Amberlite IR120 H⁺ form resin and 1 L 3M KOH, prepared from KOH(s) (BDH9262, VWR International, Radnor, PA) and DI H₂O, were added and agitated by roller mill for 1.5 h. The resin slurry was added to a column and washed with several gallons of DI H₂O to achieve pH 7 eluting solvent. Passed 426 g PFMI^{H} dispersion (PE4) over the beads and monitored pH of eluate. Half the volume of dispersion collected was at pH 4, so dispersion was followed with an equivalent volume of 85/15 MeOH/H₂O (w/w) solvent. The beads were washed with 1 L of 3 M KOH(aq) followed by several gallons of DI H₂O to achieve pH 7 eluting solvent. The diluted dispersion was run over the beads again and the last 25% of the dispersion was collected at pH 5-6. The resin was again washed with 1 L of 3 M KOH(aq) and subsequent water wash to pH 7 eluting solvent. The dispersion was contacted over the beads a third time, collecting all fractions at pH 7, followed by air. Dispersion was added to a 4-mil-PTFE lined glass tray and oven dried at 100° C. for several hours until dry to collect 25.11 g PFMI K⁺.

### Comparative Example (CE1) PFMI H⁺

PFMI H⁺ solids (PE5) were dispersed in 75/25 EtOH/H₂O (w/w) at 30% solids at room temperature with gentle agitation until no gels were observed. The dispersion was filtered through 1 micrometer glass microfiber syringe filters and coated 10 mil (0.25 mm) wet onto 2 mil (0.051 mm) polyimide film upon a glass substrate with a Gardco notch bar (Paul N. Gardner Company, Inc, Pompano Beach, FL) and dried under an aluminum pan covering in a forced air oven at 120° C. for 30 minutes. The polyimide and coating were transferred to an aluminum pan with aluminum pan covering and heated to 140° C. for 15 minutes and ramped to 160° C. for a 10-minute hold to produce 30 micrometer thick proton exchange membranes. The films were removed from the polyimide and titrated according to the EW Measurement method described above; observed EW was 1177 g/mol. The T(α) was determined to be 70.0° C. by DMA-2 method.

### Example 1 (E1) PFMI Na⁺

A dispersion was prepared by combining 10 g PE5 and 20 g of pre-mixed 75/25 EtOH/H₂O (w/w) into an HDPE (high density polyethylene) bottle and rolling to redisperse overnight.

The dispersion was coated following Coating Method 1 with a 15 mil (0.38 mm) gap upon a PTFE liner and annealed at 200° C. to form a membrane. Film thickness was determined to be 42 micrometers thick by drop gauge micrometer. T(α) was determined to be 120.8° C. by DMA-2 method.

### Example 2 (E2) PFMI K⁺

A dispersion was prepared by combining 10 g PE5 and 20 g of pre-mixed 75/25 EtOH/H₂O (w/w) into an HDPE bottle and rolling to redisperse overnight.

The dispersion was coated following Coating Method 1 with a 15 mil (0.38 mm) gap upon a PTFE liner and annealed at 200° C. to form a membrane. Film thickness was determined to be 42 micrometers thick by drop gauge micrometer. T(α) was determined to be 139.8° C. by DMA-2 method.

### Comparative Example 2 (CE2) PFSA H⁺

FSO₂C₄F₈OCF═CF₂ was prepared as described in U.S. Pat. No. 6,624,328. Tetrafluoroethylene and FSO₂C₄ F₈OCF═CF₂ were copolymerized as described in U.S. Pat. No. 7,348,088. The resulting fluoropolymer comprising FSO₂ terminated sidechains was expected to have an equivalent weight of about 798 g/mol.

The polymer was coated according to Film Coating Method 2 and subjected to 200° C. annealing heat treatment. The resulting film was measured to be 50 micrometers thick by drop gauge micrometer. T(α) was determined to be 114.9° C. by DMA-2 method.

### Comparative Example 3 (CE3) PFSA Na⁺

A 0.507 g sample of CE2 was submerged in 48.1 g of 1 M NaCl(aq), prepared from NaCl and DI H₂O. The film and solution were rolled for three days, after which the solution was decanted and replaced with 55 mL DI H₂O with gentle shaking three times to exchange H⁺ for Na⁺ in the film. The resulting film was blotted dry with paper towels and set on a silicone treated polypropylene liner (Loparex, Cary, NC), placed into a glass jar with activated 3 angstrom molecular sieves and placed into a vacuum oven at 80° C., full vacuum overnight. T(α) was determined to be greater than 200.0° C. by DIvLA-2 method.

### Comparative Example 4 (CE4) PFSA H⁺

A membrane was coated from a 20 wt % aqueous copolymer dispersion wherein the copolymer derived from tetrafluoroethylene and a 2-└1-└difluoro[(trifluoroethenyl)oxy┘methyl┘-1,2,2,2-tetrafluoroethoxy]-1,1,2,2-tetrafluoro ethanesulfonic acid. The aqueous copolymer dispersion available under the trade designation “NAFION DE2020” from Ion Power Inc., New Castle, DE, as received, according to Film Coating Method 2 and annealed at 160° C. for 10 minutes. T(α) was determined to be 87.0° C. by DMA-2 method.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail,

What is claimed is:

1. A method of making a polymer electrolyte membrane, the method comprising:
disposing a liquid composition on a substrate, wherein the liquid composition comprises an ionic fluorinated polymer, wherein the ionic fluorinated polymer comprises a plurality of side chains having a protogenic group in a salt form, and wherein the fluorinated polymer has a T(α) of less than 200° C.

2. The method of claim 1, wherein the protogenic group is selected from a bis(sulfonyl)imide salt, a sulfonyl methide salt, and combinations thereof.

3. The method of claim 1, wherein the bis(sulfonyl)imide salt is a bis(sulfonyl)imide metal salt, wherein the metal is selected from Na, K, Li, V, Cs, Fe, Cr, Ce, Mn, or mixtures thereof.

4. The method of claim 1, wherein the side chain comprises 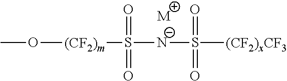
where x is 0, 1, 2, 3, 4, 5, or 6; m is 2, 3, 4, 5, or 6, and M^{⊕} is a suitable counter cation.

5. The method of claim 1, wherein the ionic fluorinated polymer has an equivalent weight of at least 700 and at most 1200 grams/mole.

6. The method of claim 1, wherein the ionic fluorinated polymer is a highly fluorinated or perfluorinated.

7. The method of claim 1, wherein the ionic fluorinated polymer is derived from at least a tetrafluoroethylene monomer and a vinyl ether monomer.

8. The method of claim 1, wherein the liquid composition comprises a solvent, optionally wherein the solvent is water.

9. The method of claim 8, further comprising drying the liquid composition on the substrate.

10. The method of claim 1, wherein the substrate is a supporting matrix.

11. The method of claim 1, wherein the liquid composition is an extrudate.

12. The method of claim 1, wherein the substrate is a temporary substrate.

13. The method of claim 12, wherein the temporary substrate comprises a polyolefin or a polyester.

14. The method of claim 1, further comprising annealing the ionic fluorinated polymer after disposing the liquid composition on the substrate.

15. The method of claim 14, wherein the annealing is at a temperature below 200° C.

16. A polymer electrolyte membrane made according to claim.

17. An electrochemical cell comprising the polymer electrolyte membrane made according to claim 16.

18. The electrochemical cell of claim 17, wherein the electrochemical cell is a flow battery.

19. A method of making sulfonyl fluoride-containing polymer into a bis(sulfonyl)imide salt polymer, the method comprising:
reacting a polymer comprising a plurality of side chains having a sulfonyl fluoride group with ammonia to form a corresponding sulfonamide polymer;
treating the corresponding sulfonamide polymer with an excess of aprotic amine to generate a corresponding sulfonamide trialkylammonium salt;
treating the sulfonamide trialklammonium salt with another small molecule sulfonyl fluoride to generate a corresponding bis(sulfonyl)imide polymer; and
contacting the corresponding bis(sulfonyl)imide polymer with a hydroxide base to form the bis(sulfonyl)imide salt polymer.
